(19) United States
(12) Patent Application Publication
(10) Pub. No.: US 2009/0208689 A1
(43) Pub. Date: Aug. 20, 2009

(54) DETECTING THE ENERGY INPUT INTO A SOLID OR A WORKPIECE

(76) Inventor: Claus Peter Kluge, Roslau (DE)

Correspondence Address: FULBRIGHT & JAWORSKI, LLP, 666 FIFTH AVE, NEW YORK, NY, 10103-3198, US

(21) Appl. No.: 12/300,158

(22) PCT Filed: May 21, 2007
(86) PCT No.: PCT/EP07/54879

§ 371 Date: Nov. 10, 2008

(30) Foreign Application Priority Data
May 23, 2006 (DE) 10 2006 024 510.5

(51) Int. Cl. B32B 5/14; B44C 1/22

(52) U.S. Cl. 428/43; 216/57; 216/83; 216/58

(57) ABSTRACT

A method of introducing weakening into a solid or a workpiece, preferably a ceramic or a glass, by an energy source which, by means of specific energy input acting locally, weakens the solid or the workpiece at the location of the energy input. A chromophore substance is applied to the location of the energy input before or at the same time as the energy input, such that a physical, chemical or biological visible change in the solid body or the workpiece is achieved at the location of the energy input.

The invention relates to a method for introducing weakenings into a solid or a workpiece, preferably a ceramic or a glass, by means of an energy source which, by specific or targeted introduction of energy acting locally, weakens the solid or the workpiece at the site of the introduction of energy, and to a solid or workpiece treated in this way.

There are various methods for applying markings to or below the surface of solid materials, such as scratching with hard, pointed objects or the THERMARK method (DE 195 41 53 A1) in which a laser is used to transfer and fix coloured particles from, for example, an adhesive tape to the surface of a workpiece.

The method requires careful coordination of the tape material, the colouring body, the spacing of the tape from the planar workpiece surface.

Alternatively, the colouring substances (glasses, particles) can also be printed or sprayed on before they are solidified on the surface of the workpiece.

The method gives rise to an at least temporary solidification, of the colouring bodies on the surface of the workpiece so a certain local unsharpness, not least as a result of spattering of the material, becomes unavoidable. Surplus material needs to be removed again.

These methods do not provide a depth effect that is required (penetration of chromophores into cracks)

Likewise, it is prior art to introduce into a workpiece by means of a laser with removal of material a scratch or notch structure that can generally easily be identified with the eye or with image-identification systems and thus facilitates separation.

The invention describes inter alia a marking method for a. workpiece shaped in any way and made from ceramic, glass, metal or combinations thereof. The structure is introduced, in a specific or targeted way sequentially with a focused energy source or through a temporary mask with the aid of a suitable dispersive energy source in the x-, y- and optionally also in the z-direction.

The marking itself can be irreversible, reversible or just temporary (transient).

In this connection, the marking can either be introduced directly at the desired points or, after the workpiece has been completely processed, be worked out subtractively by removing at non-designated points the negative structures again in a specific way.

The marking is brought about by a chemical reaction of a material with the workpiece, by material intercalation of a substance in the workpiece, by structural change or local change of certain chemical, physical or biological properties of the workpiece.

The energy source can be a burner, a UV-, VIS or IR-radiator, but also a mechanical energy source, such as a local stretching.

The structure that is introduced can be detected, for example, with the eye in the case of colour changes in the visible range or else with the aid of physical-chemical detectors.

In one development, the invention therefore relates to a method for introducing weakenings into a solid or a workpiece, preferably a ceramic or a glass, by means of an energy source which, by means of specific introduction of energy acting locally, weakens the solid at the site of the introduction of energy.

In accordance with the invention, before arid/or at the same time as the introduction of energy, chromophoric materials are applied to the site of the introduction of energy so that a physical, chemical or biological visible change in the solid or the workpiece is achieved at the site of the introduction of energy.

In another development, the invention relates to a solid or a workpiece, preferably a ceramic or a glass, having a locally introduced weakening that extends from the surface of the workpiece (1) into the interior thereof.

In accordance with the invention, the weakening is detectable and/or marked in colour by chromophoric materials that have been introduced or have penetrated.

### EXAMPLES

A) If a laser method is used that does not operate in an ablating manner and produces, for example, just one two-dimensional break line without removal of material, or if the energy of the laser beam is reduced to such an extent that no point of separation is produced in the structure or surface damage no longer occurs on the workpiece, this, with the laser or another energy source operating in a punctiform, linear or areal manner, can be identified only with precisely adapted illumination or can no longer be identified at all.

For such a marking or separating process, what is also desired is that there be simple re-identifiability of the positions crossed that is realizable quickly, precisely and without outlay in terms of apparatus and without foreign materials that are applied changing the geometry of the workpiece as a result of their own volume.

The surface of the workpiece is cooled in a shock-like manner directly after the introduction of the energy by means of a cooling liquid, in the simplest case an aqueous medium, in which case, however, the energy that is introduced is also used to bring about a reaction between the cooling liquid, or substances dissolved therein (for example chromophoric substances), and the surface of the workpiece (ceramic, metal-ceramic, glass), by means of which the trace of the energy source can still be tracked after the treatment.

The chromophoric substances penetrate into a mechanically intact surface in the same way as in the case of energy input that produces cracks they follow these cracks and wet the inner surface of these cracks and given suitable energy input also react with the surface. In this case, these chromophoric substances are absorbed by the workpiece or they react herewith (in delimitation over the THERMARK method) without measurable volume change. Surplus chromophores do not need to be removed mechanically or chemically.

Such substances, which under the influence of heat form strongly coloured spinels, such as cobalt salts or chromium salts or iron salts or zinc salts or combinations of at least two salts, are particularly well suited, for example, for a workpiece made of white aluminium oxide. With suitable metering (for example 0.01-50 g/litre cooling liquid), water-resistant, fine grey lines are obtained along the cracks that are introduced, which lines are visible to the naked eye and facilitate, for example, adjustment for further work steps or subsequent separation.

B) Fine structural damage is introduced into a workpiece with a laser. The coolant or its chromophoric constituents likewise penetrate into the cracks and remain there even after evaporation of volatile constituents of the coolant.

The invention accordingly relates to solids, preferably ceramics or glasses, into which by means of locally acting energy sources, for example a laser beam or burner, a break line is introduced which as a rule is not visible. Greater ease of separation of the solids into smaller units is achieved by means of this break line.

In accordance with the invention, at the same time as the introduction of energy, colouring, that is, chromophoric, materials are applied to the site of the introduction of energy so that a physical, chemical or biological visible change in the break line is achieved.

The break, line is as a result marked in a permanent and detectable manner.

If the application of colouring materials to the site of the introduction of energy were not. effected at the same time as or immediately with respect to the introduction of energy, the break line would re-close and marking would only be possible on the surface of the solid.

An areal, ceramic carrier body that is covered with a biological nutrient solution may be mentioned as a further example.

After production, that is, after sintering, marked break lines are introduced into the ceramic carrier body and subsequently coated with the nutrient solution. The user can then break himself off individual, pieces, making out the site of the break lines by means of the marking.

Owing to the fact that chromophoric materials are applied to the site of the introduction of energy before and/or at the same time as the introduction of energy so that a physical, chemical or biological visible change in the solid or the workpiece is achieved at the site of the introduction of energy, the site of the introduction of energy is marked and the solid or the workpiece can easily be processed further or be used further.

The solid or workpiece can have chromophoric materials applied to part of or all over its surface and in accordance with the invention only thereafter be treated.

In this case, the application of chromophoric materials to the solid or the workpiece can be effected in any sequence and frequency.

The chromophoric materials can be dissolved or suspended or dispersed or be pulverized or be used in combinations of these states.

The chromophoric materials are preferably elements or their compounds of vanadium or manganese or copper or silver or tungsten or nickel or cobalt or chromium or iron or zinc or combinations of at least two of these elements or compounds of at least one of these elements or combinations of compounds and/or elements.

In one embodiment of the invention, carrier liquids are used in. which the chromophoric materials are mixed, and the carrier liquids are solutions or suspensions or dispersions, or combinations thereof, of the chromophoric materials, with concentrations of at least one chromophoric material in at least 0.01 gram/litre carrier liquid. This carrier liquid is applied to the site of the introduction of energy before and/or at the same time as the introduction, of energy.

In another embodiment of the invention, carrier substances are used in which pulverized, chromophoric material is mixed, and the concentration of the chromophoric material, amounts to at least one part of 0.001% by weight of the carrier substance, and the carrier substance contains at least one adhesion promoter and/or at least one binding agent, and/or further additional materials or combinations thereof.

Carrier liquids and/or carrier substances can be used in any order,, singly or in multiples, with the same or different compositions for each solid or workpiece.

The colour intensity can be adjusted for carrier liquids and/or carrier substances by means of different concentrations of the chromophoric materials in the carrier liquid and/or carrier substance, with a rise in the concentration of the chromophoric materials in the carrier liquid and/or carrier substance being proportional to the intensity of the resultant discolouration in the solid or workpiece (1).

The colour intensity can also be adjusted for a carrier liquid and/or carrier substance by differing energy input, of the energy source, in which case given the same concentration and composition of the carrier liquid and/or carrier substance a rise in the energy input leads to a change in the intensity of the discolouration.

The concentration of the chromophoric materials in the carrier liquid and/or carrier substance and/or the intensity of the energy input can be changed in order to adjust the discolouration.

The change in the intensity of the discolouration, is used in an inventive application to judge the weakening and/or the degree of weakening of the solid or workpiece.

Before and/or during the energy input at least, one further solid or liquid material can also be associated with the site of the introduction of energy, and the material can penetrate into the weakening during or after the energy input.

Preferably fluorescin or resorcin or fuchsin or combinations thereof are suitable for this further material.

In an inventive development at least one carrier liquid and/or one carrier substance is fed by way of at least one feed to the site of energy input, in a mariner synchronized with the energy input. The feed can, for example, be a tube or a feed arrangement.

Preferably at least one carrier liquid and/or one carrier substance is mixed in a supply container or actively stirred fed to the site of energy input in a metered or non-metered manner.

A separate supply container can be used in each case for each carrier liquid and/or carrier substance, and the outflows of the supply containers can be connected together in parallel and/or in series and. during the method the same or different quantities can be removed from the supply containers in a metered or non-metered manner.

In addition, at least one carrier liquid and/or carrier substance can be mixed and/or fed in parallel with at least one further material that is required for the method and is liquid or gaseous or is in combinations of these states.

A solid or workpiece, preferably consisting of a ceramic or a glass which has been treated according to the method in accordance with, the invention is distinguished in that it has a locally introduced weakening that extends from the surface of the solid or workpiece into the interior thereof, and the weakening is detectable and/or marked in colour by chromophoric materials that have penetrated.

The materials can preferably be stimulated so that they are fluorescent by means of radiation, preferably UV light.

The material of the solid or workpiece in one embodiment consists of one of the following material-groups or combinations thereof:
a) “aluminium oxide” with a main component part of >50.1% by weight aluminium oxide
b) “zirconium oxide” with a main component part of >50.1% by weight zirconium oxide
c) “aluminium nitride” with a main component part of >50.1% by weight aluminium nitride
d) “silicon nitride” with a main component part of >50.1% by weight silicon nitride,

and as additives the material preferably contains CaO or SiO₂ or MgO or B₂O₃ or Y₂O₃ or Sc₂O₃ or CeO₂ or Cu oxides or metals or impurities <=2% by weight or combinations thereof.

In one embodiment related or separate coloured regions with the same and/or different discolouration and/or intensity of discolouration are arranged on the solid or workpiece.

In one form of application at least one all-over or part-covering carrier liquid and/or carrier substance, containing chromophoric materials, is arranged on the solid or workpiece, and this solid or workpiece treated in this way is used as a starting product for the method in accordance with the invention or the solid or workpiece in accordance with the invention.

This starting product or the solid or workpiece treated in this way can be used to determine the intensity and/or the variation in intensity of at least one energy source.

The solid or the workpiece (starting product) can also be used, to adjust at least one energy-input process and/or to evaluate the constancy of the energy-input process and/or to archive the result of the energy input.

The invention is explained in greater detail in the following with the aid of figures.

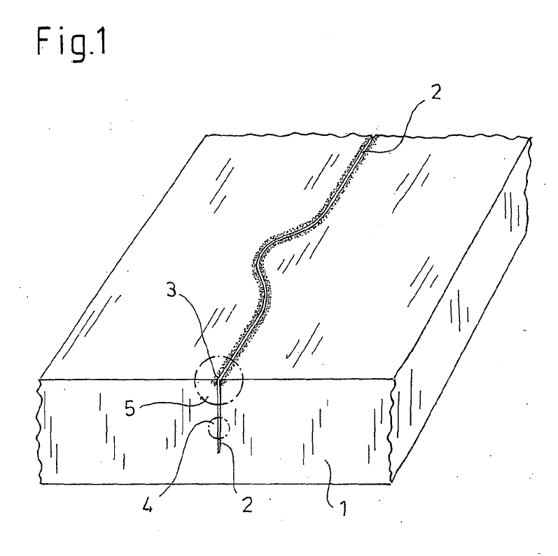

FIG. 1 shows a solid or workpiece 1 with a local mechanical weakening 2 that has been introduced, or a predetermined breaking point or generally a break line,

A colour or a chromophoric material which has developed by itself as a result of a solid-chemical reaction during the local heat treatment for the production of the weakening 2 is denoted by the reference numeral 3.

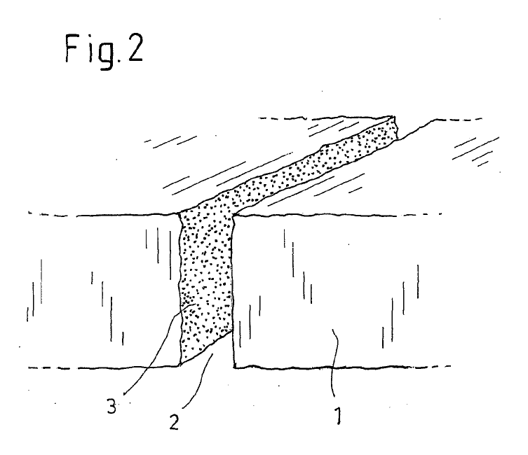

The reference numeral 4 marks a cut-out enlargement that is shown on an enlarged scale in FIG. 2.

The reference numeral 5 marks a cut-out enlargement that is

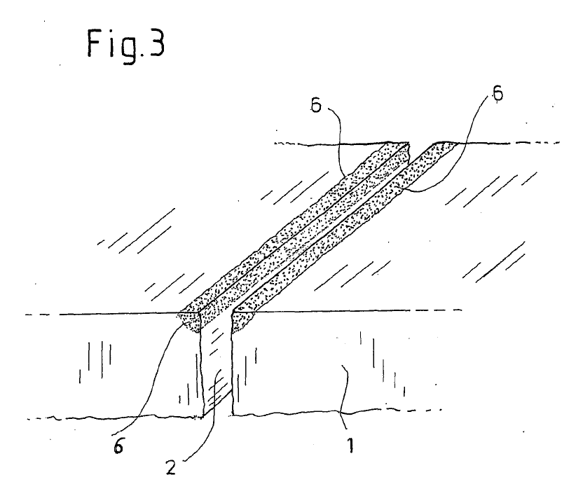

shown on an enlarged scale in FIG. 3.

FIG. 2 shows the cut-out 4 of FIG. 1 on an enlarged scale, with the solid or the workpiece 1 with the weakening 2 that has been introduced. A particulate or deposited colouring material 3 has penetrated into this weakening into the micro-cavity in the workpiece at the site of the introduction of energy that was created for a short time as a result of the introduction of energy or heat treatment.

FIG. 3 shows the cut-out 5 of FIG. 1 on an enlarged scale. A weakening 2 is introduced into the solid or the workpiece 1. The reference numeral 6 is used to denote a reaction zone in which the material of the workpiece 1 with a salt compound during the heat treatment has resulted in a local change in colour in the workpiece 1.

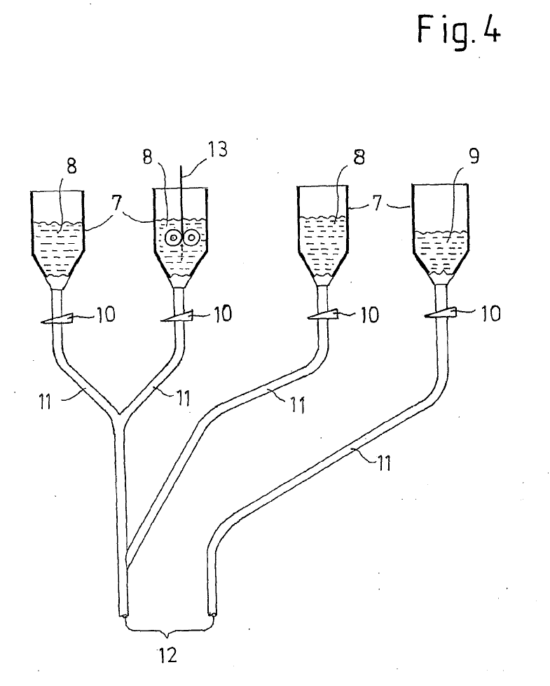

FIG. 4 shows an arrangement for feeding the chromophoric materials to the site of the introduction of energy. The chromophoric materials are in this case contained in a carrier liquid 8 or in a carrier substance 9 and are located in supply containers 7. A stirring apparatus 13 for improved intermixing of the chromophoric materials in the carrier liquid 8 is arranged, in one supply container.

The carrier liquid 8 and/or the carrier substance 9 reach/reaches the outflows 11 by way of a metering arrangement 10, for example valves, and from the outflows 11 by way of the feeds 12 reach/reaches the site of the introduction of energy to the solid or the workpiece.

1-25. (canceled)

26. A method for introducing weakenings into a solid or a workpiece by means of an energy source which, by means of targeted introduction of energy acting locally, weakens the solid or the workpiece at the site of the introduction of energy, wherein before or at the same time as the introduction of energy a chromophoric material is applied to the site of the introduction of energy so that a physical, chemical or biological visible change in the solid or the workpiece is achieved at the site of the introduction of energy.

27. A method according to claim 26, wherein the solid or the workpiece has a chromophoric material applied to part of or all over its surface.

28. A method according to claim 26, wherein the chromophoric material is applied to the solid or the workpiece in any sequence and frequency.

29. A method according to claim 26, wherein the chromophoric material is dissolved or suspended or dispersed or are pulverized or are used in combinations of these states.

30. A method according to claim 26, wherein the chromophoric material is an element or a compound of vanadium, manganese, copper, silver, tungsten, nickel, cobalt, chromium, iron or zinc or a combination thereof.

31. A method according to claim 26, wherein a carrier liquid is used in which the chromophoric materials are mixed, and the carrier liquid is a solution, a suspension or a dispersion, or a combination thereof, having a concentration of the chromophoric material in at least 0.01 gram/liter carrier liquid.

32. A method according to claim 26, wherein a carrier substance is provided in which the chromophoric material in pulverized form is mixed, and the concentration of the chromophoric material is at least one part of 0.001% by weight of the carrier substance, and the carrier substance contains at least one adhesion promoter or binding agent.

33. A method according to claim 26, wherein a carrier liquids or carrier substance is provided in any order, singly or in multiples, with the same or different compositions for each solid or workpiece.

34. A method according to claim 26, wherein the color intensity is adjusted for a carrier liquid or a carrier substance by providing different concentrations of the chromophoric materials in the carrier liquid or carrier substance, with a rise in the concentration of the chromophoric materials in the carrier liquid or carrier substance being proportional to the intensity of the resultant discoloration in the solid or workpiece.

35. A method according to claim 26, wherein the color intensity is adjusted for a carrier liquid or carrier substance by differing energy input of the energy source, in which case given the same concentration and composition of the carrier liquid or carrier substance a rise in the energy input leads to a change in the intensity of the discoloration.

36. A method according to claim 26, wherein the concentration of the chromophoric materials in the carrier liquid or carrier substance or the intensity of the energy input are changed in order to adjust the discoloration.

37. A method according to claim 26, wherein the change in the intensity of the discoloration is used to judge the weakening or the degree of weakening of the solid or workpiece.

38. A method according to claim 26, wherein before or during the energy input at least one further solid or liquid material is associated with the site of the introduction of energy, and the material penetrates into the weakening during or after the energy input.

39. A method according to claim 38, wherein the further material is fluorescin or resorcin or fuchsin or a combination thereof.

40. A method according to claim 26, wherein at least one carrier liquid or one carrier substance is fed by way of at least one feed to the site of energy input, in a manner synchronized with the energy input.

41. A method according to claim 26, wherein at least one carrier liquid or one carrier substance is mixed in a supply container or is actively stirred and is fed to the site of energy input in a metered or non-metered manner.

42. A method according to claim 26, wherein a separate supply container is used in each case for each carrier liquid or carrier substance, and the outflows of the supply containers are connected together in parallel or in series and during the method the same or different quantities are removed from the supply containers in a metered or non-metered manner.

43. A method according to claim 26, wherein at least one carrier liquid or carrier substance is mixed or fed in parallel with at least one further material that is required for the method and is liquid or gaseous or is in combinations of these states.

44. A method according to claim 44, wherein the workpiece comprises at least one of ceramic or glass.

45. A solid or workpiece comprising a ceramic or a glass and having a locally introduced weakening that extends from the surface of the solid or workpiece into the interior thereof, wherein the weakening is detectable or marked in color by chromophoric materials that have penetrated.

46. A solid or workpiece according to claim 45, wherein the materials can be stimulated so that they are fluorescent by means of radiation.

47. A solid or workpiece according to claim 45, wherein the material of the solid or the workpiece consists of one of the following material-groups or combinations thereof:
a) aluminum oxide comprising >50.1% by weight aluminum oxide
b) zirconium oxide comprising >50.1% by weight zirconium oxide
c) aluminum nitride comprising >50.1% by weight aluminum nitride
d) silicon nitride comprising >50.1% by weight silicon nitride,
and as additives the material preferably contains CaO or SiO₂ or MgO or B₂O₃ or Y₂O₃ or Sc₂O₃ or CeO₂ or Cu oxides or metals or impurities <=2% by weight or combinations thereof.

48. A solid or workpiece according to claim 45, wherein related or separate colored regions with the same or different discoloration or intensity of discoloration are arranged on the solid or workpiece.

49. A solid or workpiece comprising a ceramic or a glass, wherein at least one all-over or part-covering carrier liquid or carrier substance, containing chromophoric materials, is located on the solid or workpiece, for use in particular as a starting product for the method according to claim 26.

50. A solid or workpiece according to claim 49, wherein the solid or workpiece is used to determine the intensity or the variation in intensity of at least one energy source.

51. A solid or workpiece according to claim 49, wherein the solid or workpiece is used to adjust at least one energy-input process or to evaluate the constancy of the energy-input process or to archive the result of the energy input.

52. A solid or workpiece comprising a ceramic or a glass, wherein at least one all-over or part-covering carrier liquid or carrier substance, containing chromophoric materials, is located on the solid or workpiece, for use as a solid workpiece according to claim 45.
